(19) United States
(12) Patent Application Publication
(10) Pub. No.: US 2011/0208834 A1
(43) Pub. Date: Aug. 25, 2011

(54) ONBOARD INFORMATION SYSTEM

(76) Inventors: Soichi Nagano, Tokyo (JP); Wataru Yamazaki, Tokyo (JP)

(21) Appl. No.: 13/127,734

(22) PCT Filed: Sep. 24, 2009
(86) PCT No.: PCT/JP2009/004816

§ 371 Date: May 5, 2011

(30) Foreign Application Priority Data
Dec. 5, 2008 (JP) 2008-310893

(51) Int. Cl. G06F 15/16

(52) U.S. Cl. 709/217

(57) ABSTRACT

An onboard information system has multiple onboard apparatuses and an external communication unit 6 connected to an in-vehicle LAN 7, and multiple mobile devices 8 connected to the external communication unit via communication. A mobile device transmits a communication request to the external communication unit which transmits an ID assigned to the request-originating mobile device and an initial operation picture to the request-originating mobile device. The request-originating mobile device transmits an onboard apparatus selected in the initial operation picture and the ID to the external communication unit which transmits, when the ID is valid, an apparatus operation picture to the request-originating mobile device. The request-originating mobile device transmits a command selected in the apparatus operation picture to the onboard apparatus which transmits a processing result corresponding to the command to the request-originating mobile device via the external communication unit. The request-originating mobile device outputs the processing result.

### TECHNICAL FIELD

The present invention relates to an onboard information system mounted on a vehicle, and particularly to a technique for improving convenience of the onboard information system.

### BACKGROUND ART

Recently, onboard information systems have been developed which have a plurality of onboard apparatuses such as a navigation system, a monitor and an AV (Audio Visual) apparatus connected to an in-vehicle LAN (Local Area Network), and enable navigation or appreciation of a motion picture or music while the plurality of onboard apparatuses carry out communications between them.

However, there are now only a few onboard information systems having a plurality of monitors connected. In particular, as for a car capable of seating comparatively many passengers up to 7-8, seats are arranged in three rows, for example, and it is difficult for a person at a back seat to view or control a monitor mounted in the front. On the other hand, as for a vehicle, which usually only one or two passengers get on and the back seats of which are seldom taken, it is uneconomical to mount a monitor for the backseats that are used infrequently.

In view of this, a technique has been developed for increasing the convenience of the onboard information system using an external apparatus. For example, Patent Document 1 discloses an onboard information system capable of setting a destination or a place on a route on an onboard navigation system from a mobile device outside a car before driving.

### PRIOR ART DOCUMENT

### Patent Document

Patent Document 1: Japanese Patent Laid-Open No. 2003-329474.

### DISCLOSURE OF THE INVENTION

The onboard information system disclosed in the foregoing Patent Document 1 supposes that only one user accesses the onboard navigation system. Thus, development of the technique is desired which enables a plurality of users on a car to gain access to the onboard information system through communication.

The present invention is implemented to meet the foregoing needs. Therefore it is an object of the present invention to provide an onboard information system that enables a plurality of users to gain access to a plurality of onboard apparatuses connected to a network using a mobile device of each user.

To solve the foregoing problem, an onboard information system in accordance with the present invention includes: a plurality of onboard apparatuses connected to a LAN; an external communication unit which is connected to the LAN for carrying out communication with the outside; and a plurality of mobile devices which are connected to the external communication unit via communication to gain access to the plurality of onboard apparatuses, wherein one of the plurality of mobile devices transmits as a request-originating device a communication request to the external communication unit; the external communication unit assigns an ID to the request-originating mobile device in response to the communication request received from the request-originating mobile device, and transmits the assigned ID and an initial operation picture including icons representing the plurality of onboard apparatuses to the request-originating mobile device; the request-originating mobile device transmits, to the external communication unit, apparatus information indicating an onboard apparatus selected by designation of an icon in the initial operation picture received from the external communication unit, and the ID received from the external communication unit; the external communication unit transmits, when the ID received from the request-originating mobile device is valid, an apparatus operation picture including commands for operating the onboard apparatus designated by the apparatus information received from the request-originating mobile device to the request-originating mobile device; the request-originating mobile device transmits a command selected from the commands in the apparatus operation picture received from the external communication unit to the onboard apparatus designated by the apparatus information; the onboard apparatus executes processing corresponding to the command received from the external communication unit and transmits a processing result to the external communication unit; the external communication unit transmits the processing result received from the onboard apparatus to the request-originating mobile device; and the request-originating mobile device outputs information corresponding to the processing result received from the external communication unit.

According to the onboard information system in accordance with the present invention, it can access the plurality of apparatuses connected to the LAN by connecting a mobile device brought in from the outside to the external communication unit via the communication, thereby being able to acquire information displayed on the apparatuses or to operate the apparatuses.

### BRIEF DESCRIPTION OF THE DRAWINGS

FIG. 1 is a block diagram showing a configuration of an onboard information system of an embodiment 1 in accordance with the present invention;

FIG. 2 is a block diagram showing another configuration of the onboard information system of the embodiment 1 in accordance with the present invention;

FIG. 3 is a block diagram showing a configuration of an external communication unit used in the onboard information system of the embodiment 1 in accordance with the present invention;

FIG. 4 is a sequence diagram showing the operation of causing a mobile device to display information generated by the navigation system in the onboard information system of the embodiment 1 in accordance with the present invention;

FIG. 5 is a flowchart showing details of communication request receiving processing shown in FIG. 4;

FIG. 6 is a flowchart showing details of onboard apparatus selection receiving processing shown in FIG. 4;

FIG. 7 is a flowchart showing details of command receiving processing shown in FIG. 4;

FIG. 8 is a flowchart showing details of onboard apparatus data receiving processing shown in FIG. 4;

FIG. 9 is a sequence diagram showing the operation of causing the mobile device to display information generated by a DVD player in the onboard information system of the embodiment 1 in accordance with the present invention;

FIG. 10 is a flowchart showing details of the onboard apparatus selection receiving processing shown in FIG. 9;

FIG. 11 is a sequence diagram showing the operation when another mobile device has already been controlling a DVD player in the onboard information system of the embodiment 1 in accordance with the present invention;

FIG. 12 is a sequence diagram showing the operation of controlling a DVD player by acquiring a priority during the acquisition of data from the DVD player in the onboard information system of the embodiment 1 in accordance with the present invention;

FIG. 13 is a flowchart showing details of priority request receiving processing shown in FIG. 12; and

FIG. 14 is a block diagram showing another configuration of the onboard information system of the embodiment 1 in accordance with the present invention.

### DESCRIPTION OF EMBODIMENTS

Embodiments of the present invention will be described with reference to the accompanying drawings to explain the present invention in more detail.

### Embodiment 1

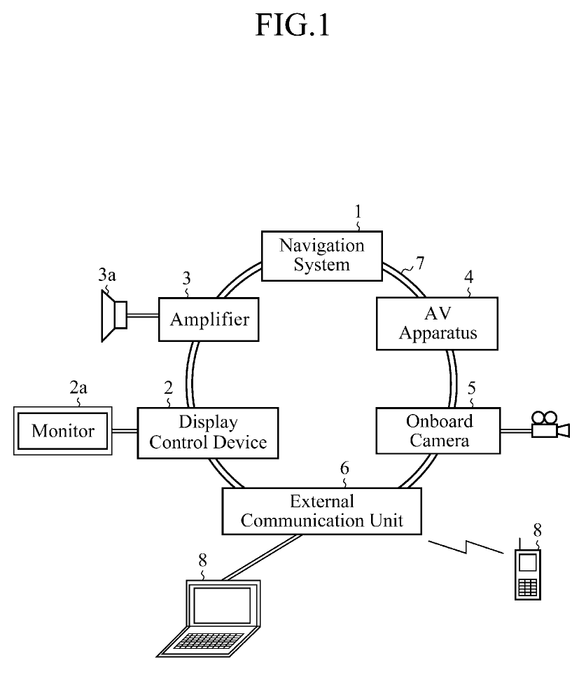

FIG. 1 is a block diagram showing a configuration of an onboard information system of an embodiment 1 in accordance with the present invention. The onboard information system is constructed by connecting onboard apparatuses such as a navigation system 1, a display control device 2, an amplifier 3, an AV apparatus 4 and an onboard camera 5, and an external communication unit 6 to an in-vehicle LAN 7. The in-vehicle LAN 7 corresponds to a LAN in accordance with the present invention.

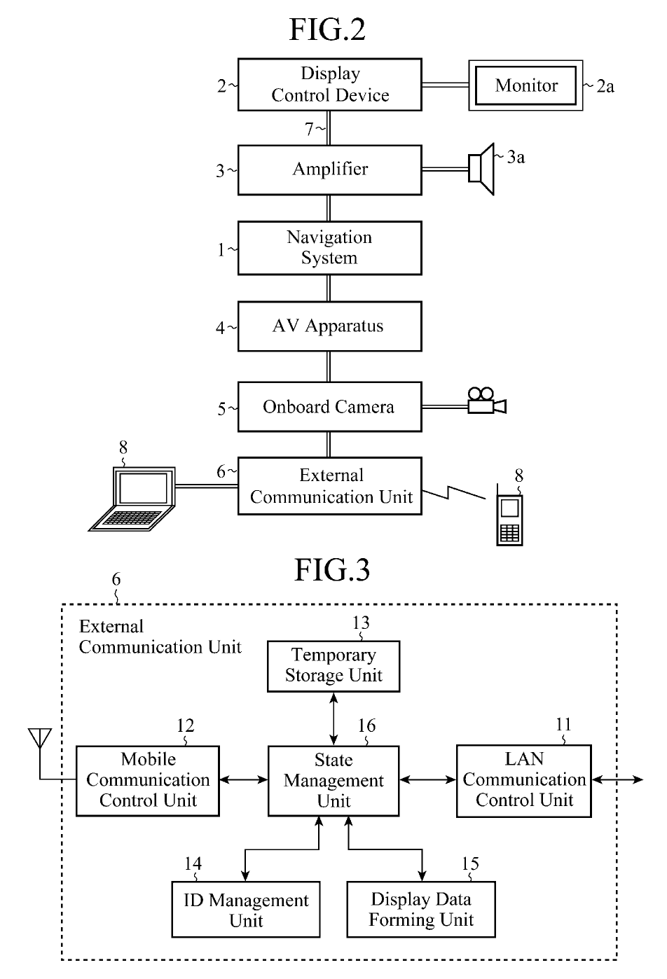

Incidentally, although the onboard information system shown in FIG. 1 employs a ring LAN, it can also use a bus LAN as shown in FIG. 2. In addition, it is also possible to use a wired LAN using a cable or a wireless LAN without using a cable as a LAN. In addition, a configuration is also possible which connects the plurality of onboard apparatuses using Bluetooth.

The navigation system 1 executes processing for carrying out navigation functions such as route search and route guidance. A processing result by the navigation system 1 is delivered to the display control device 2, amplifier 3 and external communication unit 6 via the in-vehicle LAN 7.

To the display control device 2, a monitor 2a is connected. The display control device 2 generates a drawing signal from a video signal delivered from the navigation system 1, AV apparatus 4, onboard camera 5 and external communication unit 6 via the in-vehicle LAN 7, and delivers to the monitor 2a. The monitor 2a displays an image based on the drawing signal delivered from the display control device 2.

To the amplifier 3, a speaker 3a is connected. The amplifier 3 amplifies a voice signal delivered from the navigation system 1, AV apparatus 4 or external communication unit 6 via the in-vehicle LAN 7, and delivers to the speaker 3a. The speaker 3a produces sounds in response to the amplified voice signal delivered from the amplifier 3.

The AV apparatus 4 comprises a DVD (Digital Versatile Disk) player, a DTV (Digital Television) or a game machine, for example. The DVD player reproduces data recorded on a DVD loaded to generate a video signal and voice signal, and delivers to the display control device 2, amplifier 3 and external communication unit 6. The DTV generates a video signal and voice signal from a radio wave received and delivers to the display control device 2, amplifier 3 and external communication unit 6. The game machine reproduces data recorded on a recording medium to generate a video signal and voice signal, and delivers to the display control device 2, amplifier 3 and external communication unit 6.

The onboard camera 5 takes a picture around the vehicle. An image taken is delivered to the display control device 2 as a video signal.

To the external communication unit 6, a plurality of mobile devices 8 are connected via a cable, infrared rays or a communication method using a weak radio signal such as Bluetooth. The external communication unit 6 controls the cable communication, infrared ray communication or communication using a weak radio signal with the external mobile devices 8. As the mobile devices 8, a personal computer, mobile phone, PDA (Personal Digital Assistant), mobile game machine or mobile music player and the like can be used.

Incidentally, the mobile devices 8 can be configured in such a manner as to be connected to the external communication unit 6 using a card slot. In addition, the external communication unit 6 can be included in one of the onboard apparatuses, or can be mounted on one of the onboard apparatuses using a connector.

Next, details of the external communication unit 6 will be described. FIG. 3 is a block diagram showing a configuration of the external communication unit 6. The external communication unit 6 comprises a LAN communication control unit 11, a mobile communication control unit 12, a temporary storage unit 13, an ID management unit 14, a display data forming unit 15 and a state management unit 16.

The LAN communication control unit 11 controls communication with the onboard apparatuses connected to the in-vehicle LAN 7. More specifically, the LAN communication control unit 11 receives data delivered from the onboard apparatuses via the in-vehicle LAN 7 and delivers to the state management unit 16, and sends data delivered from the state management unit 16 to the onboard apparatuses via the in-vehicle LAN 7.

The mobile communication control unit 12 controls communications with the plurality of mobile devices 8. More specifically, the mobile communication control unit 12 receives data from the plurality of mobile devices 8 and delivers to the state management unit 16, and sends data delivered from the state management unit 16 to the plurality of mobile devices 8.

The temporary storage unit 13 temporarily stores data delivered from the state management unit 16. The data stored in the temporary storage unit 13 is read out by the state management unit 16. The ID management unit 14 manages a proper number (ID) assigned to each of the plurality of mobile devices 8. The IDs generated by the state management unit 16 are stored in the ID management unit 14, and the IDs stored in the ID management unit 14 are read out by the state management unit 16.

The display data forming unit 15 creates display data from data delivered from the state management unit 16. The display data created by the display data forming unit 15 is delivered to the state management unit 16. The state management unit 16 controls the LAN communication control unit 11, mobile communication control unit 12, temporary storage unit 13, ID management unit 14 and display data forming unit 15. Details of the processing executed by the state management unit 16 will be described later.

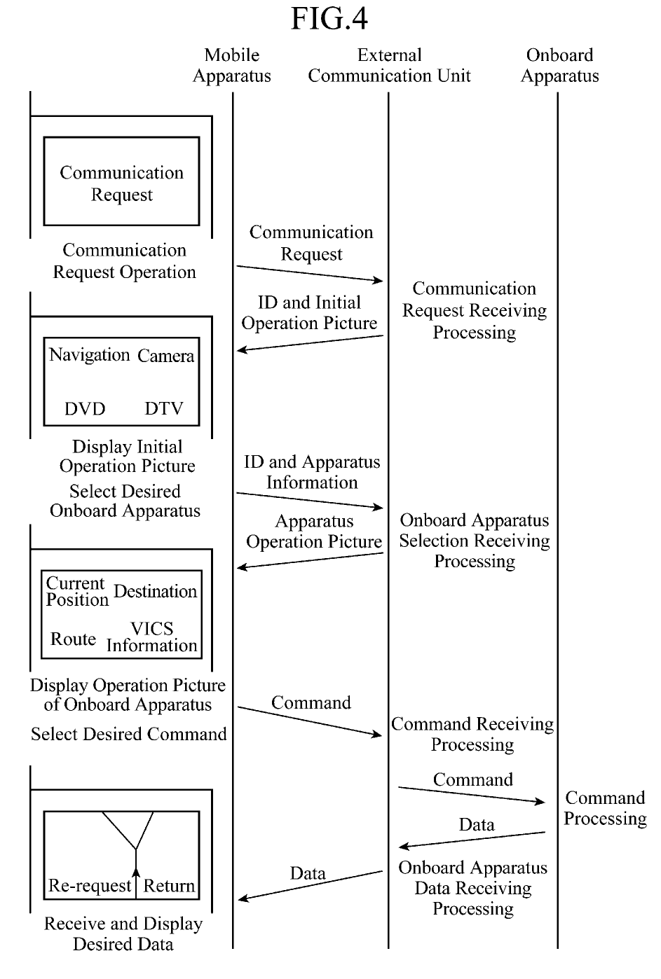

Next, the operation of the onboard information system of the embodiment 1 in accordance with the present invention with the foregoing configuration will be described. FIG. 4 is a sequence diagram showing the operation in the case where a user operates the navigation system 1 serving as an onboard apparatus from a mobile device 8 to cause the mobile device 8 to display the information formed by the navigation system 1 in response to the operation.

When a communication request is made via one of the plurality of mobile devices 8, the mobile device 8 (corresponding to a “request-originating mobile device” in accordance with the present invention) sends a communication request to the external communication unit 6. The external communication unit 6 executes communication request receiving processing in response to the communication request.

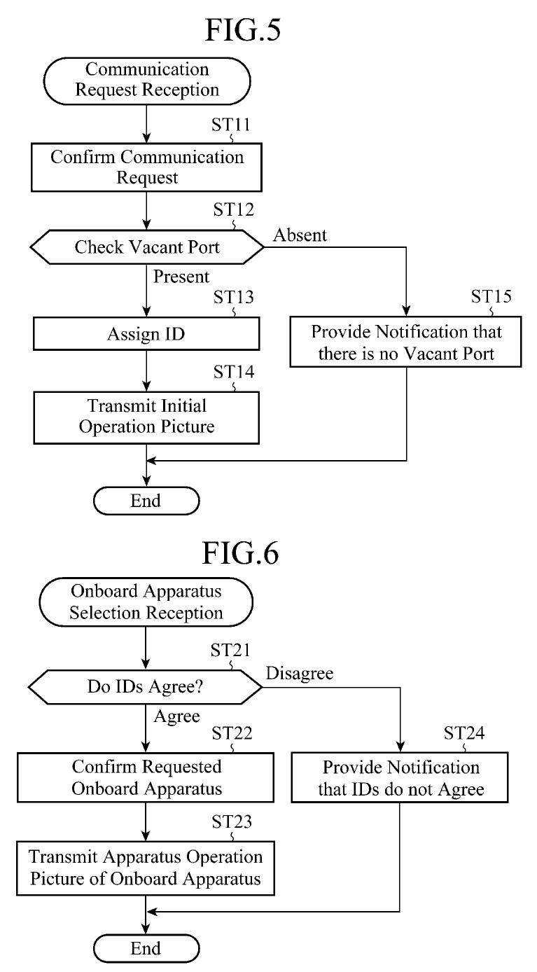

FIG. 5 is a flowchart showing details of the communication request receiving processing executed by the external communication unit 6. The communication request receiving processing confirms the communication request, first (step ST11). More specifically, the mobile communication control unit 12 receives the communication request from the mobile device 8 and delivers it to the state management unit 16. The state management unit 16 confirms that it receives the communication request.

Subsequently, a vacant port is checked (step ST12). More specifically, the state management unit 16 checks whether there is a vacancy in communication ports or not. At step ST12, if a decision is made that there is a vacancy in the ports, ID assignment is made (step ST13). More specifically, the state management unit 16 assigns an ID to the mobile device 8 from which the communication request is sent. The ID assigned by the state management unit 16 is delivered to the ID management unit 14 to be stored.

Subsequently, an initial operation picture is transmitted (step ST14). More specifically, the state management unit 16 requests the display data forming unit 15 to create the initial operation picture. In response to the request, the display data forming unit 15 generates display data representing the initial operation picture (referred to as “initial operation picture data” from now on) and delivers to the state management unit 16. The state management unit 16 delivers the initial operation picture data received from the display data forming unit 15 and the ID assigned at step ST13 to the mobile communication control unit 12. Thus, the ID and the initial operation picture data are transmitted from the mobile communication control unit 12 to the mobile device 8. After that, the communication request receiving processing is terminated.

At the foregoing step ST12, if a decision is made that there is no vacant port, notification of that is provided (step ST15). More specifically, the state management unit 16 requests the display data forming unit 15 to create a message stating that there is not a vacant port. In response to the request, the display data forming unit 15 generates the display data showing that there is no vacant port, and delivers it to the state management unit 16. The state management unit 16 delivers the display data received from the display data forming unit 15 to the mobile communication control unit 12. Thus, the display data representing that there is no vacant port is transmitted from the mobile communication control unit 12 to the mobile devices 8. After that, the communication request receiving processing is terminated.

Receiving the ID and initial operation picture data from the external communication unit 6, the mobile device 8 stores the ID in its inside, and displays on its screen icons of operable onboard apparatuses generated from the initial operation picture data such as “navigation”, “camera”, “DVD” and “DTV”. In this case, the navigation system 1, onboard camera 5, the DVD player as the AV apparatus 4 and the DTV as the AV apparatus 4 are shown to be operable. A user selects the icon of an onboard apparatus he or she wishes to operate from the icons displayed in the initial operation picture. When one of the icons is selected in the initial operation picture, the apparatus information associated with the onboard apparatus corresponding to the selected icon and the ID are transmitted to the external communication unit 6. In this case, the mobile device 8 can be configured in such a manner as to transmit picture information defining characteristics of its screen. Incidentally, when the mobile device 8 receives the display data providing notification that there is no vacant port from the external communication unit 6, it displays that message.

The external communication unit 6 receiving the apparatus information and the ID executes onboard apparatus selection receiving processing. FIG. 6 is a flowchart showing details of the onboard apparatus selection receiving processing. In the onboard apparatus selection receiving processing, the ID is checked, first (step ST21). More specifically, the mobile communication control unit 12 receives the ID and apparatus information transmitted from the mobile device 8 and delivers to the state management unit 16. The state management unit 16 checks whether the ID received from the mobile communication control unit 12 agrees with the ID stored in the ID management unit 14.

At this step ST21, if a decision is made that the IDs agree, then the requested onboard apparatus is confirmed (step ST22). More specifically, the state management unit 16 confirms that the onboard apparatus designated by the apparatus information received from the mobile communication control unit 12 is in an operable state.

Subsequently, an apparatus operation picture of the onboard apparatus is transmitted (step ST23). More specifically, the state management unit 16 requests the display data forming unit 15 to create the operation picture of the onboard apparatus confirmed at step ST22. In response to the request, the display data forming unit 15 generates the display data for showing the operation picture of the onboard apparatus (referred to as “apparatus operation picture data” from now on), and delivers to the state management unit 16. The state management unit 16 delivers the apparatus operation picture data received from the display data forming unit 15 to the mobile communication control unit 12. Thus, the apparatus operation picture data is transmitted from the mobile communication control unit 12 to the mobile device 8. After that, the onboard apparatus selection receiving processing is terminated.

At the foregoing step ST21, if the IDs do not agree, that is, a decision is made that they disagree, then a notification that the IDs disagree is provided (step ST24). More specifically, the state management unit 16 requests the display data forming unit 15 to create a message stating that the IDs do not agree. In response to the request, the display data forming unit 15 generates the display data for showing that the IDs disagree and delivers to the state management unit 16. The state management unit 16 delivers the display data it receives from the display data forming unit 15 to the mobile communication control unit 12. Thus, the display data representing the message stating that the IDs do not agree is transmitted from the mobile communication control unit 12 to the mobile device 8. After that, the onboard apparatus selection receiving processing is terminated.

On the screen of the mobile device 8, which receives the apparatus operation picture data from the external communication unit 6, commands of the onboard apparatus it selects previously are displayed as an apparatus operation picture. For example, when “navigation” is selected in the initial operation picture, the commands such as “current position”, “destination”, “route” and “VICS information” (VICS (the Vehicle Information and Communication System) is a registered trademark) are displayed on the apparatus operation picture. These commands represent the functions the navigation system 1 can execute. A user selects a desired command from among the commands displayed on the apparatus operation picture. When one of the commands is selected on the apparatus operation picture, the selected command is transmitted to the external communication unit 6. Incidentally, when the mobile device 8 receives the display data representing the message stating that the IDs do not agree from the external communication unit 6, it displays the message.

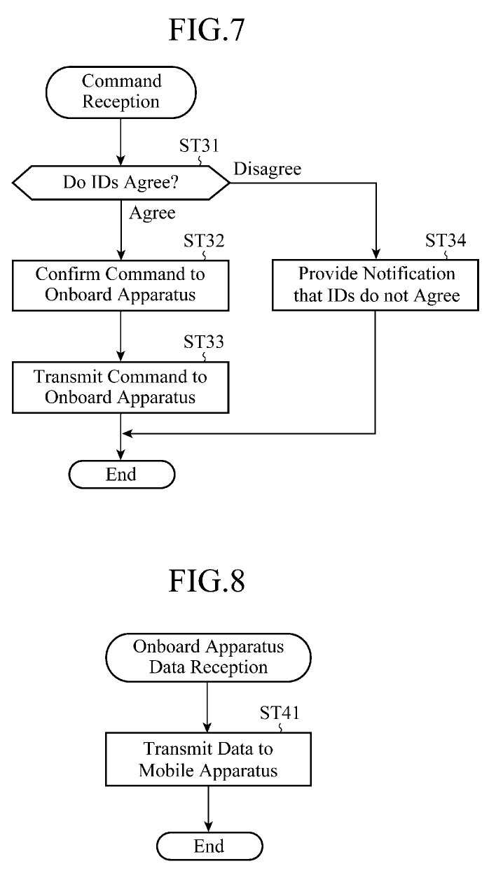

The external communication unit 6 receiving the command executes the command receiving processing. FIG. 7 is a flowchart showing details of the command receiving processing. In the command receiving processing, the ID is checked, first (step ST31). The processing at step ST31 is the same as the processing at the foregoing step ST21. If a decision is made that the IDs agree at this step ST31, then the command to the onboard apparatus is checked (step ST32). More specifically, the state management unit 16 checks whether the command it receives from the mobile communication control unit 12 is valid or not.

Subsequently, the command is transmitted to the onboard apparatus (step ST33). More specifically, the state management unit 16 delivers the command it checks at step ST32 to the LAN communication control unit 11. Thus, the LAN communication control unit 11 transmits the command received from the state management unit 16 to the onboard apparatus via the in-vehicle LAN 7. After that, the command receiving processing is terminated.

If a decision is made that the IDs do not agree at the foregoing step ST31, then the notification that the IDs do not agree is provided (step ST34). The processing at step ST34 is the same as the processing at the foregoing step ST24. Thus, the display data representing the message stating that the IDs do not agree is transmitted from the mobile communication control unit 12 to the mobile device 8. After that, the command receiving processing is terminated.

The onboard apparatus receiving the command from the external communication unit 6 executes the processing corresponding to the command (command processing). The data representing the result of the command processing is transmitted to the external communication unit 6.

The external communication unit 6 receiving the data representing the processing result from the onboard apparatus executes the onboard apparatus data receiving processing. FIG. 8 is a flowchart showing the onboard apparatus data receiving processing. In the onboard apparatus data receiving processing, processing of transmitting data to the mobile device 8 is executed (step ST41). More specifically, the LAN communication control unit 11 receives the data representing the processing result from the onboard apparatus and delivers to the state management unit 16. The state management unit 16 delivers the data representing the processing result received from the LAN communication control unit 11 to the mobile communication control unit 12. Thus, the data representing the processing result is transmitted from the onboard apparatus to the mobile device 8. This causes the mobile device 8 to display the processing result of the onboard apparatus. For example, it displays an information map indicating the vehicle mark on a map.

Incidentally, when the mobile device 8 delivers the picture information that defines characteristics of its screen, a configuration is possible in which the state management unit 16 converts the data representing the processing result received from the LAN communication control unit 11 in accordance with the picture information, followed by delivering to the mobile communication control unit 12. According to the configuration, the mobile device 8 can display an image in conditions suitable for its screen.

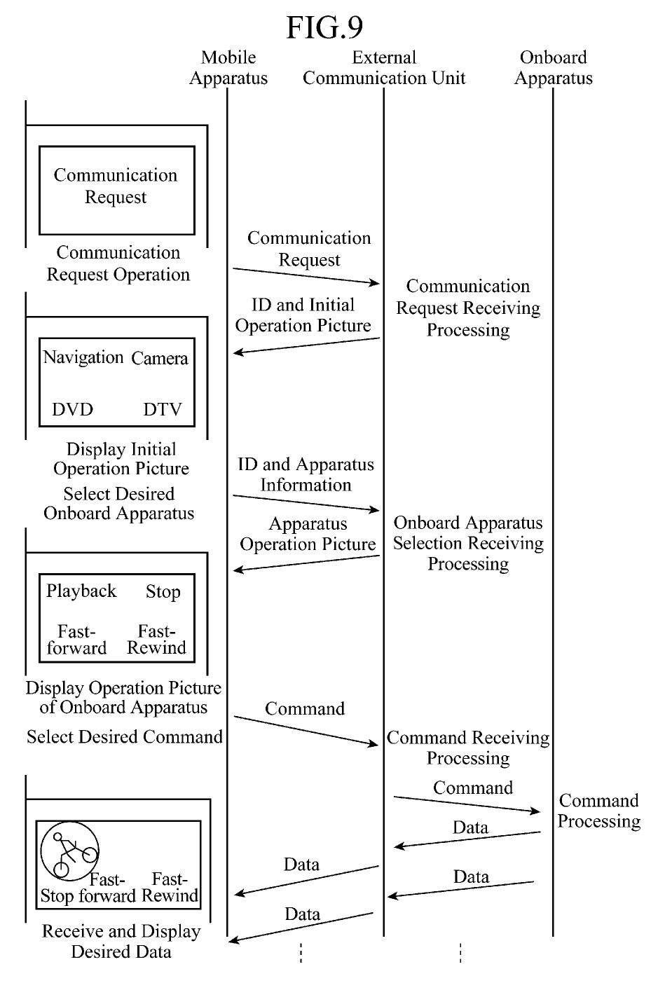

Next, the operation of causing the mobile device 8 to operate a DVD player which is one of the AV apparatus 4 serving as the onboard apparatus, and to display the information generated by the DVD player on the mobile device 8 in response to the operation will be described with reference to the sequence diagram shown in FIG. 9.

The operation from the communication request made by one of the plurality of mobile devices 8 up to the display of the initial operation picture is the same as the operation of causing the mobile device 8 to display the information from the navigation system 1 as described above.

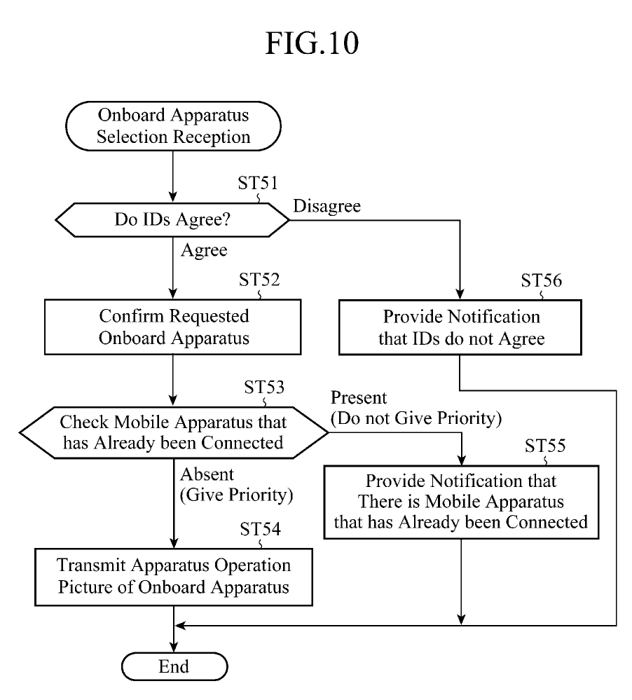

A user selects an icon of an onboard apparatus he or she wishes to operate from the icons displayed on the initial operation picture. In this case, the user selects the icon of “DVD”. When the “DVD” is selected from the initial operation picture, the mobile device 8 transmits the ID and the apparatus information designating the selected onboard apparatus (DVD player) to the external communication unit 6. In response to the apparatus information, the external communication unit 6 executes the onboard apparatus selection receiving processing. FIG. 10 is a flowchart showing details of the onboard apparatus selection receiving processing.

In the onboard apparatus selection receiving processing, the ID is checked, first (step ST51). The processing at step ST51 is the same as the processing at the foregoing step ST21. At this step ST51, if a decision is made that the IDs agree, then the requested onboard apparatus is checked (step ST52). The processing at step ST52 is the same as the processing at the foregoing step ST22.

Subsequently, a mobile device that has already been connected is checked (step ST53). More specifically, the state management unit 16 checks whether there is a mobile device 8 which has already been connected to the onboard apparatus (DVD player) or not. If a decision is made at this step ST53 that there is no mobile device 8 which has already been connected to the onboard apparatus, the mobile device 8 is given a priority, and the apparatus operation picture of the onboard apparatus is transmitted (step ST54). The processing at step ST54 is the same as the processing at the foregoing step ST23. Thus, the apparatus operation picture data is transmitted from the mobile communication control unit 12 of the external communication unit 6 to the mobile device 8. After that, the onboard apparatus selection receiving processing is terminated.

At the foregoing step ST53, if a decision is made that there is a mobile device 8 which has already been connected to the onboard apparatus (DVD player), notification that there is a previously connected mobile device is provided (step ST55). More specifically, the state management unit 16 requests the display data forming unit 15 to create a message stating that another mobile device 8 has already been connected. In response to the request, the display data forming unit 15 generates display data for displaying a message stating that another mobile device 8 has already been connected, and delivers to the state management unit 16. The state management unit 16 delivers the display data received from the display data forming unit 15 to the mobile communication control unit 12. Thus, the display data for displaying the message showing that another mobile device 8 has already been connected is transmitted from the mobile communication control unit 12 to the mobile device 8. After that, the onboard apparatus selection receiving processing is terminated.

At the foregoing step ST51, if a decision is made that the IDs do not agree, then notification that the IDs do not agree is provided (step ST56). The processing at step ST56 is the same as the processing at the foregoing step ST24. Thus, the display data for displaying a message indicating that IDs do not agree is transmitted from the mobile communication control unit 12 of the external communication unit 6 to the mobile device 8. After that, the onboard apparatus selection receiving processing is terminated.

On the screen of the mobile device 8 receiving the apparatus operation picture data from the external communication unit 6, the commands of the onboard apparatus (DVDplayer) that is selected previously are displayed as an apparatus operation picture. For example, when the “DVD” is selected in the initial operation picture, the commands such as “playback”, “stop”, “fast-forward” and “fast rewind” are displayed on the apparatus operation picture. They show functions that the DVD player can execute. The user selects a desired command from the commands displayed on the apparatus operation picture. When one of the commands is selected on the apparatus operation picture, the selected command is transmitted to the external communication unit 6.

The external communication unit 6 that receives the command executes the command receiving processing. The command receiving processing is the same as the command receiving processing shown in the flowchart of FIG. 7. More specifically, the external communication unit 6 transmits the command received from the mobile device 8 to the onboard apparatus (DVD player). The onboard apparatus receiving the command from the external communication unit 6 executes the processing corresponding to the command and transmits the data representing the processing result to the external communication unit 6. The external communication unit 6 transmits the data received from the onboard apparatus to the mobile device 8. After that, the processing of transmitting data from the onboard apparatus to the mobile device 8 via the external communication unit 6 is executed repeatedly. Thus, the mobile device 8 displays the processing result of the onboard apparatus, that is, the video played back by the DVD player.

Although the foregoing embodiment 1 is described by way of example in which the mobile device 8 accesses the navigation system 1 and the DVD player serving as the AV apparatus 4, other onboard apparatuses can also be controlled in nearly the same manner. In addition, although it is described by way of example in which an image is displayed on the screen of the mobile device 8 according to the data acquired from the onboard apparatus, the data acquired from the onboard apparatus can contain voice data or text data or the like. Furthermore, a configuration is also possible which transmits data stored in the mobile device 8 to the onboard apparatus to be output.

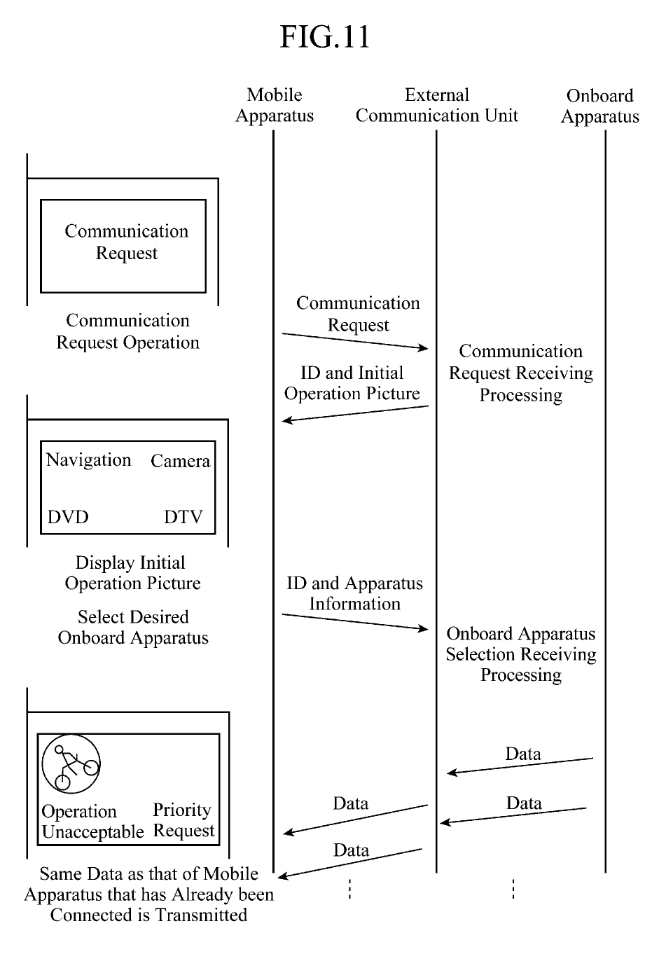

Next, the operation when another mobile device 8 is already operating the DVD player when the mobile device 8 is going to operate the DVD player which is one of the AV apparatus 4 serving as the onboard apparatus will be described with reference to the sequence diagram shown in FIG. 11.

As for the operation from the communication request made by one of the plurality of mobile devices 8 up to the transmission of the ID and apparatus information to the external communication unit 6 after selecting the “DVD” on the initial operation picture, it is the same as the operation of displaying the information from the foregoing navigation system 1 on the mobile device 8.

The external communication unit 6 that receives the ID and apparatus information executes the onboard apparatus selection receiving processing. The onboard apparatus selection receiving processing checks the ID (step ST51) and the requested onboard apparatus (step ST52) in the same manner as the onboard apparatus selection receiving processing shown in FIG. 10. After that, when a decision is made in the confirmation of the previously connected mobile device (step ST53) that there is a second mobile device 8 that has already been connected to the onboard apparatus (DVD player), the state management unit 16 of the external communication unit 6 repeatedly transmits the data representing the processing result which is received from the onboard apparatus and is transmitted to the previously connected second mobile device 8 to the mobile device 8 that sends the communication request. Accordingly, the mobile device 8 that sends the communication request displays the same pictures as the previously connected second mobile device 8, which are played back by the DVD player.

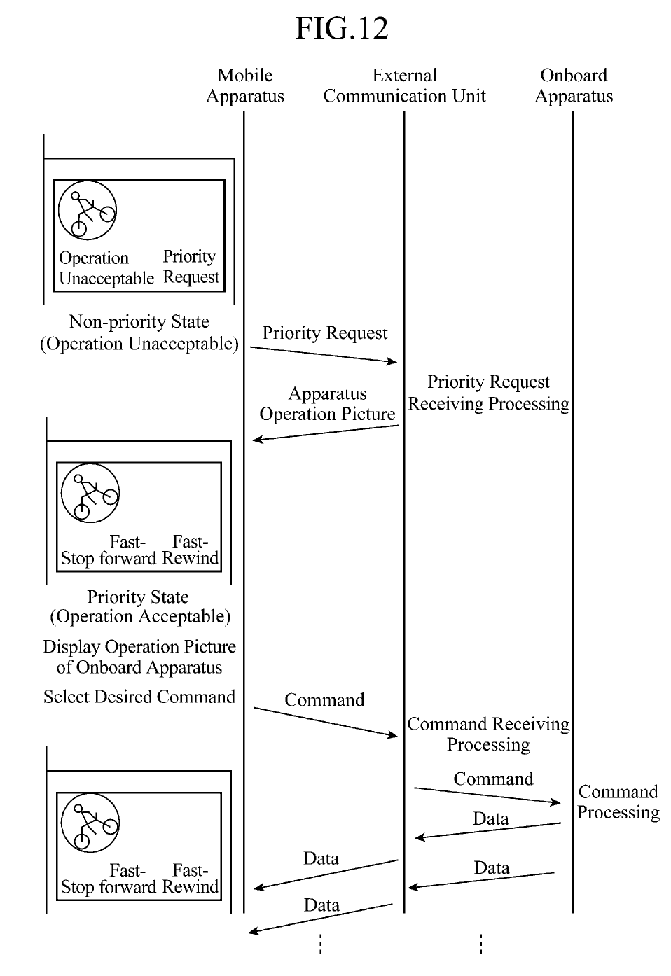

Next, the operation when a mobile device 8, which is not given priority and has a low priority of being unable to operate the onboard apparatus, acquires a priority to control the DVD player while it is acquiring data from the DVD player which is one of the AV apparatus 4 serving as the onboard apparatus will be described with reference to the sequence diagram shown in FIG. 12.

On the mobile device 8 in the low priority, a priority request button as well as a message stating that the operation is impossible is displayed. When a priority request operation is performed by pushing the priority request button on the mobile device 8, a priority request is transmitted from the mobile device 8 to the external communication unit 6. In response to the priority request, the external communication unit 6 executes the priority request receiving processing.

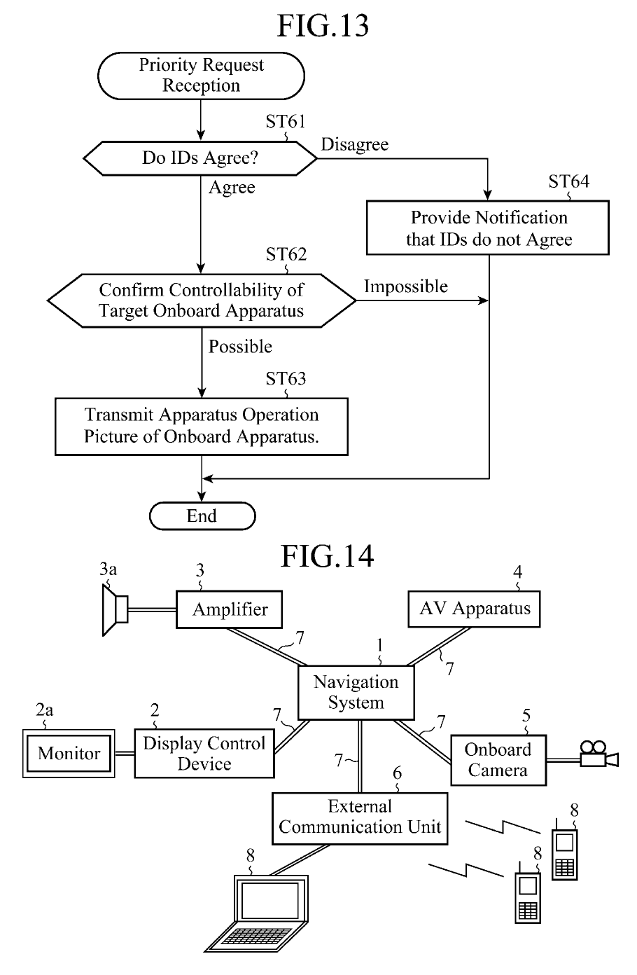

FIG. 13 is a flowchart showing details of the priority request receiving processing executed by the external communication unit 6. In the priority request receiving processing, the ID is confirmed, first (step ST61). The processing at step ST61 is the same as the processing at the foregoing step ST21. At step ST61, if a decision is made that the IDs agree, then the controllability of a target onboard apparatus is checked (step ST62). More specifically, the state management unit 16 checks whether the onboard apparatus indicated by the apparatus information previously received from the mobile communication control unit 12 is in an operable state or not.

At this step ST62, if a decision is made that the target onboard apparatus is uncontrollable, the priority request receiving processing is terminated. In contrast, if a decision is made at step ST62 that the target onboard apparatus is controllable, an apparatus operation picture of the onboard apparatus is transmitted (step ST63). The processing at step ST63 is the same as the processing at the foregoing step ST23. Thus, the apparatus operation picture data is transmitted from the mobile communication control unit 12 of the external communication unit 6 to the mobile device 8. After that, the priority request receiving processing is terminated.

If a decision is made at the foregoing step ST61 that the IDs do not agree, that is, disagree, then notification that the IDs do not agree is given (step ST64). The processing step ST64 is the same as the processing at the foregoing step ST24. After that, the priority request receiving processing is terminated.

On the screen of the mobile device 8 receiving the apparatus operation picture data from the external communication unit 6, the commands of the onboard apparatus selected are displayed as an apparatus operation picture. For example, when the “DVD” is selected in the previous initial operation picture, the commands such as “stop”, “fast-forward” and “fast rewind” are displayed on the apparatus operation picture. The commands show functions the DVD player can execute. The user selects a desired command from the commands displayed on the apparatus operation picture. When one of the commands is selected on the apparatus operation picture, the selected command is transmitted to the external communication unit 6. The operation thereafter is the same as the operation described with reference to FIG. 9.

Incidentally, if the onboard apparatus transmits data during the foregoing operation, the external communication unit 6 transmits the data to the mobile device 8, and the mobile device 8 continues the operation of displaying the data received.

Incidentally, as a switching method between the priority and low priority, either a method requiring permission of the mobile device 8 having the priority or a method not requiring it can be used. In addition, a method can also be employed which enables operation from any of the mobile devices 8 when no operation is carried out for a certain time period.

Furthermore, although the foregoing embodiment 1 shows the DVD as an example of the target onboard apparatus for acquiring data, other devices such as a DTV, a radio or audio set can also be used as a target. Besides, when an HDD (Hard Disk Drive) can be used as a target onboard apparatus for acquiring data, a configuration is also possible which transmits different data to the individual mobile devices rather than transmitting the same data as in the case of the DVD. In this case, since the data processing is performed at a high speed, it is not necessary to distinguish between the priority and low priority among the mobile devices, and the individual mobile devices can carry out independent operation.

As described above, according to the onboard information system of the embodiment 1 in accordance with the present invention, the mobile devices 8, which are brought in from the outside, can access the plurality of onboard apparatuses connected to the in-vehicle LAN 7 by being connected to the external communication unit 6 via communication, thereby being able to acquire information displayed on the onboard apparatuses or to operate the onboard apparatuses. Accordingly, a passenger can acquire the information displayed on the onboard apparatuses easily by bringing his or her own mobile device 8 into the vehicle without requiring the owner of the vehicle to mount the monitor 2a or the like on all the seats of the vehicle.

Incidentally, FIG. 1, FIG. 2 and FIG. 14 show only examples of a system configuration. For example, an apparatus not shown in the drawings (such as ETC onboard equipment and other AV apparatuses) can be connected, or the apparatus shown in the drawings (such as the onboard camera) need not be connected.

### INDUSTRIAL APPLICABILITY

An onboard information system in accordance with the present invention makes it possible to access a plurality of apparatuses connected to a LAN to acquire information displayed on the apparatuses or to operate the apparatuses. Accordingly, it is suitable for an onboard information system which has a plurality of onboard apparatuses connected there to such as a navigation system, a monitor and an AV apparatus, and which enables navigation, appreciation of music and the like through communications between the onboard apparatuses.

1. An onboard information system comprising:
an onboard apparatus connected to a LAN; and
an external communication unit which is connected to the LAN for carrying out communication with the outside, and which enables a mobile device to access the onboard apparatus,
wherein
the external communication unit assigns an ID to the mobile device in response to a communication request received from the mobile device, and transmits the assigned ID and an initial operation picture including an icon representing the onboard apparatus to the mobile device;
the external communication unit, which receives apparatus information and the ID transmitted from the mobile device, transmits, when the ID received is valid, an apparatus operation picture which enables selection of a command for operating the onboard apparatus designated by the apparatus information received from the mobile device to the mobile device;
the external communication unit, which receives the command to the onboard apparatus transmitted from the mobile device, transmits the command to the onboard apparatus;
the onboard apparatus, which receives the command from the external communication unit, executes processing corresponding to the command and transmits a processing result to the external communication unit; and
the external communication unit transmits the processing result received from the onboard apparatus to the mobile device.

2. The onboard information system according to claim 1, wherein
the external communication unit, which receives the apparatus information and the ID transmitted from the mobile device, transmits, when the received ID is valid and when the onboard apparatus designated by the apparatus information operates in response to a communication request from another mobile device, information that the mobile device is not given priority; and gives, when the received ID is valid and when the onboard apparatus designated by the apparatus information does not operate in response to a communication request from another mobile device, a priority to the mobile device, and transmits to the mobile device an apparatus operation picture including commands for operating the onboard apparatus designated by the apparatus information received from the mobile device.

3. The onboard information system according to claim 2, wherein
the external communication unit, which receives the apparatus information and the ID transmitted from the mobile device, transmits, when transmitting a processing result received from the onboard apparatus designated by the apparatus information to the another mobile device having a priority, the processing result transmitted to the another mobile device to the mobile device.

4. The onboard information system according to claim 3, wherein
the external communication unit, which receives the priority request, the apparatus information and the ID transmitted from the mobile device, gives a priority to the mobile device when the received ID is valid and when the onboard apparatus designated by the apparatus information is controllable, and transmits to the mobile device an apparatus operation picture including commands for operating the onboard apparatus designated by the apparatus information.

5. An external communication unit of an onboard information system, which is connected to a LAN to which an onboard apparatus is connected, for carrying out communication with the outside and for enabling a mobile device to access the onboard apparatus, wherein the external communication unit of the onboard information system:
assigns an ID to the mobile device in response to a communication request received from the mobile device, and transmits the assigned ID and an initial operation picture including an icon representing the onboard apparatus to the mobile device;
receives the apparatus information and the ID transmitted from the mobile device, and transmits, when the received ID is valid, an apparatus operation picture which enables selection of a command for operating the onboard apparatus designated by the apparatus information received from the mobile device to the mobile device;
transmits the command to the onboard apparatus when receiving the command transmitted from the mobile device to the onboard apparatus; and
transmits a processing result of processing corresponding to the command received from the onboard apparatus to the mobile device.

6. The external communication unit of an onboard information system according to claim 5, wherein
the external communication unit, which receives the apparatus information and the ID transmitted from the mobile device, transmits when the received ID is valid and when the onboard apparatus designated by the apparatus information operates in response to a communication request from another mobile device, information that the mobile device is not given a priority; and gives, when the received ID is valid and when the onboard apparatus designated by the apparatus information does not operate in response to a communication request from another mobile device, a priority to the mobile device, and transmits to the mobile device the apparatus operation picture including commands for operating the onboard apparatus designated by the apparatus information received from the mobile device.

7. The external communication unit of an onboard information system according to claim 6, wherein
the external communication unit, which receives the apparatus information and the ID transmitted from the mobile device, transmits, when transmitting a processing result received from the onboard apparatus designated by the apparatus information to the another mobile device having a priority, the processing result transmitted to the another mobile device to the mobile device.

8. The external communication unit of an onboard information system according to claim 7, wherein
the external communication unit, which receives the priority request, the apparatus information and the ID transmitted from the mobile device, gives a priority to the mobile device when the ID received is valid and when the onboard apparatus designated by the apparatus information is controllable, and transmits to the mobile device an apparatus operation picture including commands for operating the onboard apparatus designated by the apparatus information.
